(19) United States
(12) Patent Application Publication
(10) Pub. No.: US 2025/0178518 A1
(43) Pub. Date: Jun. 5, 2025

(54) VARIABLE LAMP SYSTEM FOR VEHICLES THAT REDUCES GLARE

(71) Applicant: HYUNDAI MOBIS CO., LTD., Seoul (KR)

(72) Inventor: Jun Young SUNG, Yongin-si (KR)

(73) Assignee: HYUNDAI MOBIS CO., LTD., Seoul (KR)

(21) Appl. No.: 18/776,579

(22) Filed: Jul. 18, 2024

(30) Foreign Application Priority Data
Dec. 5, 2023 (KR) 10-2023-0174327

(51) Int. Cl. B60Q 1/14

(52) U.S. Cl. CPC B60Q 1/1423; B60Q 2300/338; B60Q 2300/40

(57) ABSTRACT

A variable lamp system for a vehicle includes one or more sensors to detect an object at a side or a rear of the vehicle, and acquire driving information of the object, a lighting device including one or more lamps, and a controller to control the lighting device and brightness of the one or more lamps of the lighting device based on the driving information.

### CROSS-REFERENCE TO RELATED APPLICATIONS

This application claims priority under 35 U.S.C. § 119 to Korean Patent Application No. 10-2023-0174327, filed on Dec. 5, 2023, in the Korean Intellectual Property Office, the disclosure of which is incorporated herein by reference in its entirety for all purposes.

### BACKGROUND

### 1. Field

The following disclosure relates to a variable lamp system for moving vehicles that prevents glare, and more particularly, to a variable lamp system for moving vehicles that prevents glare, the lamp system detecting an object overtaking from the side or rear of the moving vehicle and controlling brightness of a lighting device based on driving information of the object.

### 2. Description of the Related Art

In general, a vehicle may include a lighting device for a vehicle driver to clearly see an object in a driving direction when driving at night and to inform another vehicle or a pedestrian of a driving state of the vehicle.

A head lamp also referred to as a head light may be a lighting lamp illuminating a front path to which the vehicle is moved, and may require brightness enabling the driver to check an obstacle on a road that is located at a distance of 100 m in front of the vehicle at night. A different headlamp standard is set for each country, and in particular, a different irradiation direction of a head lamp beam is set based on whether the driver drives the vehicle on the left or right.

The head lamp for a vehicle may be generally used for a lighting function for the driver to see a target object and for an indicating, signaling, or warning function to inform another vehicle or another road user of the driving state of the driver's own vehicle.

A conventional head lamp for a vehicle has been introduced in an attempt to provide the driver with advantageous visibility because the head lamp may automatically adjust the irradiation direction based on the driving state such as a road environment or a vehicle condition. For example, an irradiation angle of the head lamp may be adjusted based on a steering wheel operation direction of the vehicle, that is, the head lamp may be adjusted to radiate lighting in a right direction when the vehicle turns right, and adjusted to radiate the lighting in a left direction when the vehicle turns left.

However, the conventional head lamp for a vehicle may radiate the lighting to the front without considering another vehicle overtaking from its side or rear. Therefore, the conventional head lamp for a vehicle may cause glare to a driver of another vehicle overtaking from the side or rear of the vehicle by the lighting reflected during the overtaking by a side or rearview mirror, and this momentary glare may lead to a serious accident.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

An embodiment of the present invention is directed to providing a variable lamp system for moving vehicles that prevents glare, the lamp system that prevents glare from a user (or driver) of an overtaking object by detecting the object located on the side or rear of the moving vehicle and controlling brightness of a lighting device based on driving information of the object.

In a general aspect of the disclosure, a variable lamp system for a vehicle, includes one or more sensors configured to detect an object at a side or a rear of the vehicle, and acquire driving information of the object, a lighting device including one or more lamps, and a controller configured to control the lighting device, and control brightness of the one or more lamps of the lighting device based on the driving information.

The controller may be further configured to determine a distance between the object and the vehicle based on the driving information, and control the lighting device to turn off the one or more lamps in a direction where the object is located, in response to the distance between the object and the vehicle reaching or exceeding a predetermined distance, based on location information of the object included in the driving information.

The controller may be further configured to control the lighting device to turn on the one or more lamps again in response to the object leaving a predetermined area after overtaking the moving vehicle, based on the driving information.

The controller may be further configured to control the lighting device based on speed information of the object included in the driving information.

The controller may be further configured to control the lighting device to simultaneously turn off the one or more lamps in the direction where the object is located in response to a speed of the object comprises a first speed that is faster than a predetermined speed.

The controller may be further configured to control the lighting device to be turned on after a first reference time in response to the speed of the object being the first speed.

The controller may be further configured to control the lighting device to sequentially turn off the one or more lamps in the direction where the object is located from an outer side of the moving vehicle to its center, based on the vehicle, in response to the speed of the object being a second speed that is faster than a speed of the vehicle and slower than the predetermined speed.

The controller may be further configured to control the lighting device to be turned on after a second reference time in response to the speed of the object being the second speed.

The controller may be further configured to control a light-off area of the lighting device based on the location information of the object included in the driving information.

The controller may be further configured to control the lighting device to expand the light-off area of the lighting device in response to the object being located in a lane closer to the moving vehicle.

In another general aspect of the disclosure, a lamp system for a vehicle, includes one or more sensors configured to detect and acquire driving information of another vehicle approaching a side or a rear of the vehicle, a lighting device including one or more lamps, and a controller in communication with the sensor and the lighting device, wherein the controller configured to control the lighting device, and control brightness of the one or more lamps of the lighting device based on the driving information.

The controller may be further configured to determine a distance between the object and the vehicle based on the driving information, and control the lighting device to reduce glare on the other vehicle by at least one of controlling brightness of the one or more lamps of the lighting device or redirecting light from the one or more lamps of the lighting device, based on at least one of the driving information of the other vehicle, the distance between the vehicle and the other vehicle, or a combination thereof.

The other vehicle may comprises any moving vehicle, including an automobile, truck, bus, motorcycle, bicycle, mobility vehicle, autonomous vehicle, and the like.

The driving information may include at least one or more of a speed, an acceleration, a location information, or a combination thereof of the other vehicle in relation to the vehicle.

Other features and aspects will be apparent from the following detailed description, the drawings, and the claims.

### BRIEF DESCRIPTION OF THE DRAWINGS

FIG. 1 is a configuration diagram showing a variable lamp system for moving vehicles according to an embodiment of the present invention.

FIG. 2 includes parts (a) and (b) that are exemplary diagrams showing that a lighting device is controlled by the variable lamp system for moving vehicles according to an embodiment of the present invention.

FIG. 3 includes parts (a) and (b) that are exemplary diagrams showing that the lighting device is controlled based on a speed of an object by the variable lamp system for moving vehicles according to an embodiment of the present invention.

FIG. 4 is an exemplary diagram showing that the lighting device is controlled based on a location of the object by the variable lamp system for moving vehicles according to an embodiment of the present invention.

### DETAILED DESCRIPTION

The above-mentioned purposes, features, and advantages will become more obvious from the following embodiments provided with reference to the accompanying drawings. The following descriptions of specific structures and functions are provided only to describe the embodiments based on a concept of the present invention. Therefore, the embodiments of the present invention may be implemented in various forms, and the present invention is not limited thereto. The embodiments of the present invention may be variously modified and may have several forms, and specific embodiments are thus shown in the accompanying drawings and described in detail in the specification or the present application. However, it is to be understood that the present invention is not limited to the specific embodiments, and includes all modifications, equivalents, and substitutions, included in the spirit and scope of the present invention. Terms such as “first”, “second”, or the like may be used to describe various components, and the components are not to be construed as being limited to the terms. The terms are used only to distinguish one component from another component. For example, a “first” component may be named a “second” component and the “second” component may also be named the “first” component, without departing from the scope of the present invention. It is to be understood that when one component is referred to as being “connected to” or “coupled to” another component, the corresponding component may be connected or coupled directly to another component or connected or coupled to another component with a third component interposed therebetween. On the other hand, it is to be understood that when one component is referred to as being “connected directly to” or “coupled directly to” another component, it may be connected to or coupled to another component without the other component interposed therebetween. Other expressions to describe a relationship between the components, i.e., “˜between” and “directly between” or “adjacent to” and “directly adjacent to”, should be interpreted in the same manner as above. Terms used in the specification are used only to describe the specific embodiments rather than limiting the present invention. A term of a singular number used herein is intended to include its plural number unless explicitly indicated otherwise. It should be understood that terms “include” or “have” used in this specification specify the presence of features, numerals, steps, operations, components, parts mentioned in the specification or combinations thereof, and do not preclude the presence or addition of one or more other features, numerals, steps, operations, components, parts or combinations thereof. Unless defined otherwise, it is to be understood that all the terms including technical and scientific terms, used herein, have the same meanings as those that are generally understood by those skilled in the art to which the present invention pertains. It should be interpreted that terms defined by a generally used dictionary have the same meanings as the meanings in the context of the related art, and these terms should not be ideally or excessively formally interpreted unless explicitly defined in the specification. Hereinafter, the present invention will be described in detail by describing the embodiments of the present invention with reference to the accompanying drawings. Like reference numerals proposed in each drawing denote like components.

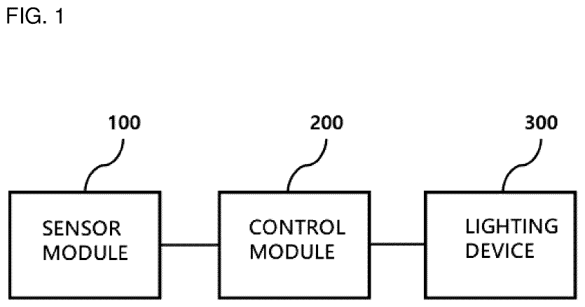

FIG. 1 is a configuration diagram showing a variable lamp system for moving vehicles according to an embodiment of the present invention.

Referring to FIG. 1, a variable lamp system for moving vehicles 10 according to an embodiment of the present invention may include a sensor module 100 (e.g., one or more sensors), a control module 200 (e.g., a controller or a processor), and a lighting device 300.

The sensor module 100 may include a sensor such as a speed sensor or an ultrasonic sensor to thus detect an object (for example, another moving vehicle overtaking the moving vehicle) approaching the moving vehicle from the side or rear of the moving vehicle and generate driving information of the detected object. The driving information provided by the sensor module 100 may include the location information and speed information of the detected object.

The lighting device 300 may include at least one light emitting diode (LED) lamp. The control module 200 may control the lighting device 300 to turn on/off each lamp (LED) or control brightness of the lamp. The lighting device 300 may include a lamp that may be redirect light.

The control module 200 may control the brightness of the lighting device 300 based on the driving information acquired from the sensor module 100. The control module 200 may control the lighting device 300 to turn off the lamp (LED) in a direction where the object is located when a distance between the object and the moving vehicle is as close as a predetermined distance, based on the location information of the object that is included in the driving information. For example, when detecting the object to overtake from the left of the moving vehicle by the sensor module 100, the control module 200 may control the lighting device 300 to partially turn off the lamp (LED) disposed on the left of the moving vehicle based on the driving information (e.g., location information or speed information) of the object. Here, the control module 200 may control the lighting device 300 to turn on the lamp (LED) again when the object leaves a predetermined area after overtaking the moving vehicle, based on the driving information. The predetermined area may be an area in a distance that does not affect glare of the user (or driver) of the object, and applied differently based on a road environment.

In addition, the control module 200 may control the lighting device 300 based on the speed information included in the driving information of the object that is acquired from the sensor module 100. For example, the control module 200 may control the lighting device 300 to simultaneously turn off the lamps (LEDs) in the direction where the object is located when a speed of the object is a first speed faster than a predetermined speed. That is, 60 km/h may be set as a speed reference for controlling the lighting device 300 to simultaneously turn off the lamps (LEDs). In this case, the control module 200 may control the lighting device 300 to simultaneously turn off the lamps (LEDs) in the direction where the object is located when the speed of the detected object is 60 km/h or more (i.e., first speed). In addition, the control module 200 may control the lighting device 300 to turn on the lamp (LED) after a first reference time because the object leaves the predetermined area faster if the object drives at the first speed of 60 km/h or more. Here, the first reference time may be faster than a general lighting time (e.g., time to turn on the lamp again when the object overtakes the vehicle at the speed of 60 km/h).

In addition, the control module 200 may control the lighting device 300 to sequentially turn off the lamps (LEDs) in the direction where the object is located from the outer side of the moving vehicle to its center when the object overtakes the moving vehicle at a second speed slower than the predetermined speed (e.g., 60 km/h). The lighting device 300 may sequentially turn off the lamps, thus radiating the lighting more smoothly and without any sense of discomfort. In addition, the control module 200 may control the lighting device 300 to turn on the lamp (LED) after a second reference time because the object leaves the predetermined area slower if the object drives at the second speed slower than 60 km/h. Here, the second reference time may be slower than the general lighting time (e.g., time to turn on the lamp again when the object overtakes the vehicle at the speed of 60 km/h).

In addition, the control module 200 may control a light-off area of the lighting device 300 based on the location information included in the driving information of the object that is acquired from the sensor module 100. For example, the control module 200 may control the lighting device 300 to expand the light-off area of the lighting device 300 as the object is located in a lane closer to the moving vehicle.

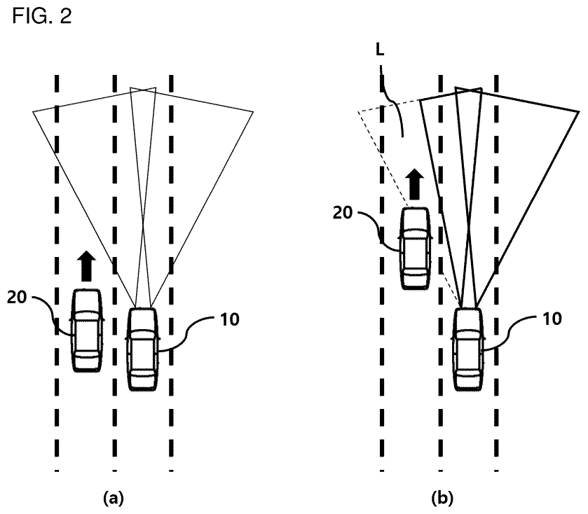

FIG. 2 includes parts (a) and (b) that are exemplary diagrams showing that the lighting device is controlled by the variable lamp system for the moving vehicles according to an embodiment of the present invention.

Referring to FIG. 2, parts (a) and (b), when an object 20 overtakes the moving vehicle 10, the control module 200 may prevent the glare from a user (or driver) of the overtaking object 20 by controlling the lighting device 300 to turn off some of the lamps (LEDs) or control the brightness of some of the lamps (LEDs). The object 20 may include any moving vehicle, including an automobile, a truck, a bus, a motorcycle, a bicycle, a mobility vehicle, an autonomous vehicle, etc.

FIG. 2, part (a) shows a situation where the object 20 is about to overtake the moving vehicle 10. Here, the sensor module 100 included in the moving vehicle 10 may detect the location and speed of the object 20 to overtake the moving vehicle 10, and generate the driving information of the object 20. The control module 200 may control the lighting device 300 based on the driving information acquired from the sensor module 100.

FIG. 2, part (b) shows a situation where the object 20 overtakes the moving vehicle 10. Here, the control module 200 included in the moving vehicle 10 may control the lighting device 300 to turn off some of the lamps (LEDs) included in the lighting device 300 based on the driving information of the object 20 that is acquired from the sensor module 100. For example, as shown in FIG. 2, part (b), the control module 200 may control the lighting device 300 to turn off the lighting in a certain area L to prevent the glare from the user (or driver) of the object 20 when the object 20 overtakes the moving vehicle 10 on the left of the moving vehicle 10. Here, the control module 200 may control the lighting device 300 to simultaneously turn off the lighting in the certain area L, or sequentially turn off the lighting from the outer side of the moving vehicle 10 to its center. In addition, the control module 200 may control the lighting device 300 to turn on the lighting in the certain area L where the lighting is turned off again when the object 20 leaves the predetermined area after overtaking the moving vehicle 10.

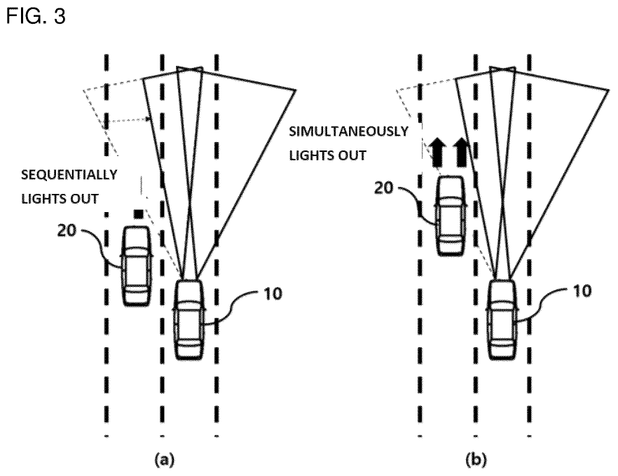

FIG. 3 includes parts (a) and (b) that are exemplary diagrams showing that the lighting device is controlled based on the speed of the object by the variable lamp system for the moving vehicles according to an embodiment of the present invention.

Referring to FIG. 3, methods of the control module 200 to control the lighting device 300 based on the speed of the object 20 may be classified into two methods.

First, FIG. 3, part (a) is an exemplary diagram showing a case where the object 20 overtakes the moving vehicle 10 at the second speed slower than the predetermined speed (e.g., 60 km/h).

The control module 200 may control the lighting device 300 to sequentially turn off the lamps (LEDs) in the direction where the object is located from the outer side of the moving vehicle to its center when the object overtakes the moving vehicle at the second speed slower than the predetermined speed (e.g., 60 km/h). The lighting device 300 may sequentially turn off the lamps, thus radiating the lighting more smoothly and without any sense of discomfort. In addition, the control module 200 may control the lighting device 300 to turn on the lamp (LED) after the second reference time because the object leaves the predetermined area slower if the object drives at the second speed slower than 60 km/h. Here, the second reference time may be slower than the general lighting time (e.g., time to turn on the lamp again when the object overtakes the vehicle at the speed of 60 km/h).

FIG. 3, part (b) is an exemplary diagram showing a case where the object 20 overtakes the moving vehicle 10 at the first speed faster than the predetermined speed (e.g., 60 km/h).

The control module 200 may control the lighting device 300 to simultaneously turn off the lamps (LEDs) in the direction where the object is located when the speed of the object is the first speed faster than the predetermined speed. That is, 60 km/h may be set as the speed reference for controlling the lighting device 300 to simultaneously turn off the lamps (LEDs). In this case, the control module 200 may control the lighting device 300 to simultaneously turn off the lamps (LEDs) in the direction where the object is located when the speed of the detected object is 60 km/h (i.e., first speed) or more. In addition, the control module 200 may control the lighting device 300 to turn on the lamp (LED) after the first reference time because the object leaves the predetermined area faster if the object drives at the first speed of 60 km/h or more. Here, the first reference time may be faster than the general lighting time (e.g., time to turn on the lamp again when the object overtakes the vehicle at the speed of 60 km/h).

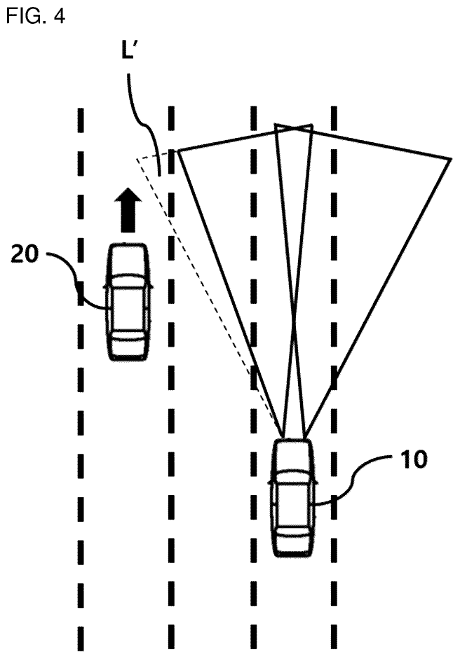

FIG. 4 is an exemplary diagram showing that the lighting device is controlled based on a location of the object by the variable lamp system for the moving vehicles according to an embodiment of the present invention.

Referring to FIG. 4, the control module 200 may control the lighting device 300 to turn off a narrower area L′ when the object 20 overtakes the moving vehicle 10 in a lane far away from the moving vehicle 10.

As shown in FIG. 4, the control module 200 may control the lighting device 300 to turn off the area L′ narrower than the light-off area L described above with reference to FIG. 2 when the object 20 overtakes the moving vehicle 10 at a location two lanes away from the moving vehicle 10. Accordingly, a driver of the moving vehicle 10 may also see a front path without any sense of discomfort, thus relieving the driver's inconvenience caused by controlling the brightness of the lighting device 300.

As set forth above, the present invention may prevent the glare from the user (or driver) of the overtaking object by controlling the brightness of the lighting device based on the driving information of the overtaking object.

In addition, the present invention may prevent an accident in advance by preventing the glare from the user (or driver) of the overtaking object.

In addition, the present invention may flexibly control the brightness of the lighting device based on the location of the overtaking object.

In addition, the present invention may flexibly control the brightness of the lighting device based on the speed of the overtaking object.

Although the embodiments of the present invention are described as above, the embodiments disclosed in the present invention are provided not to limit the spirit of the present invention, but to fully describe the present invention. Therefore, the spirit of the present invention may include not only each disclosed embodiment but also a combination of the disclosed embodiments. Further, the scope of the present invention is not limited by these embodiments. In addition, it is apparent to those skilled in the art to which the present invention pertains that various variations and modifications could be made without departing from the spirit and scope of the appended claims, and all such appropriate variations and modifications should be considered as falling within the scope of the present invention as equivalents.

What is claimed is:

1. A variable lamp system for a vehicle, the lamp system comprising:
one or more sensors configured to detect an object at a side or a rear of the vehicle, and acquire driving information of the object;
a lighting device including one or more lamps; and
a controller configured to:
control the lighting device; and
control brightness of the one or more lamps of the lighting device based on the driving information.

2. The lamp system of claim 1, wherein the controller is further configured to:
determine a distance between the object and the vehicle based on the driving information; and
control the lighting device to turn off the one or more lamps in a direction where the object is located, in response to the distance between the object and the vehicle reaching or exceeding a predetermined distance, based on location information of the object included in the driving information.

3. The lamp system of claim 2, wherein the controller is further configured to control the lighting device to turn on the one or more lamps again in response to the object leaving a predetermined area after overtaking the vehicle, based on the driving information.

4. The lamp system of claim 1, wherein the controller is further configured to control the lighting device based on speed information of the object included in the driving information.

5. The lamp system of claim 4, wherein the controller is further configured to control the lighting device to simultaneously turn off the one or more lamps in the direction where the object is located in response to a speed of the object comprises a first speed that is faster than a predetermined speed.

6. The lamp system of claim 5, wherein the controller is further configured to control the lighting device to be turned on after a first reference time in response to the speed of the object being the first speed.

7. The lamp system of claim 4, wherein the controller is further configured to control the lighting device to sequentially turn off the one or more lamps in the direction where the object is located from an outer side of the vehicle to its center, based on the vehicle, in response to the speed of the object being a second speed that is faster than a speed of the vehicle and slower than the predetermined speed.

8. The lamp system of claim 7, wherein the controller is further configured to control the lighting device to be turned on after a second reference time in response to the speed of the object being the second speed.

9. The lamp system of claim 1, wherein the controller is further configured to control a light-off area of the lighting device based on the location information of the object included in the driving information.

10. The lamp system of claim 9, wherein the controller is further configured to control the lighting device to expand the light-off area of the lighting device in response to the object being located in a lane closer to the moving vehicle.

11. A lamp system for a vehicle, comprising:
one or more sensors configured to detect and acquire driving information of another vehicle approaching a side or a rear of the vehicle;
a lighting device including one or more lamps; and
a controller in communication with the sensor and the lighting device,
wherein the controller is configured to:
control the lighting device; and
control brightness of the one or more lamps of the lighting device based on the driving information.

12. The lamp system of claim 11, wherein the controller is further configured to:
determine a distance between the object and the vehicle based on the driving information; and
control the lighting device to reduce glare on the other vehicle by at least one of controlling brightness of the one or more lamps of the lighting device or redirecting light from the one or more lamps of the lighting device, based on at least one of the driving information of the other vehicle, the distance between the vehicle and the other vehicle, or a combination thereof.

13. The lamp system of claim 11, wherein the other vehicle comprises any moving vehicle, including an automobile, a truck, a bus, a motorcycle, a bicycle, a mobility vehicle, an autonomous vehicle, and the like.

14. The lamp system of claim 11, wherein the driving information includes at least one or more of a speed, an acceleration, a location information, or a combination thereof of the other vehicle in relation to the vehicle.
